(19) United States
(12) Patent Application Publication
(10) Pub. No.: US 2006/0144037 A1
(43) Pub. Date: Jul. 6, 2006

(54) Rocket nozzle material

(75) Inventors: Arthur Metcalfe, San Diego, CA (US); Norbert Bernard Elsner, San Diego, CA (US)

Correspondence Address: JOHN R. ROSS, PO BOX 2138, DEL MAR, CA, 92014, US

(73) Assignee: HIZ CORPORATION

(21) Appl. No.: 11/030,424

(22) Filed: Jan. 6, 2005

(51) Int. Cl. F02K 9/32

(52) U.S. Cl. 60/255

(57) ABSTRACT

An aluminum burning rocket engine lining. The lining material is or includes one or more transition metal carbides of tantalum, niobium or vanadium. Applicants have determined that in aluminum burning rocket engines molten Al₂O₃ coats the inside surface of the throat of the rocket nozzle protecting certain transition metal carbides from oxidizing reactions at temperatures below a specific temperature that Applicants call the reaction initiated temperature (RIT). Applicants have proven through calculations and tests that a variety of transition metal carbide compositions as good as or better than tungsten as an engine liner material for aluminum burning rocket engines.

This invention was reduced to practice in the course of a research contract (NSWC Contract No. N00167-99-C00048) with the United States government and the government has rights in this invention.

The present invention relates to high-temperature materials and in particular to rocket nozzles lined with such materials.

### BACKGROUND OF THE INVENTION

### Rocket Engines

Rocket engines usually operate with a chamber at high pressure exhausting gasses to low external pressures. These gasses are ducted through a nozzle that converges to a throat section of smallest area and then diverges to transform much of the thermal energy of the gasses into kinetic energy. There are a number of types of nozzles. A much used type is the contoured or bell-shaped nozzle as shown at 2 in FIG. 1. This nozzle provides for rapid early expansion and directs the gasses in axial direction with respect to the axis of the nozzle.

Rockets can be liquid fueled or solid fueled. The rocket depicted in FIG. 1 is a solid fuel rocket. Solid rocket propellants are an intimate mixture containing all the material necessary for reaction. The entire block of solid propellant (called the grain and shown as 4 in FIG. 1) is stored within the combustion chamber. Combustion proceeds from the surface of the propellant. The grain is typically configured to provide the surface areas desired as the fuel burns away. The gasses, that are generated, exit through the port area 6 in FIG. 1 and then through the nozzle 2. Some of these very high temperature propellants incorporate light metals such as boron, lithium and aluminum that yield very high energies. These fuels ignite fast (about 0.025 seconds) and provide good stability. The solid fuel burns until it is all gone. Once ignited it cannot be stopped.

### Aluminum Propellants

During the 1950's and 60's researchers in the United States developed what is now the standard high-energy solid rocket fuel. The mixture is primarily ammonium perchlorate powder, NH₄ClO₄ (an oxidizer), combined with fine aluminum powder (a fuel), and held together in a base of PBAN or HTPB (rubber like fuels). The mixture is formed as a liquid at elevated temperatures and poured into the rocket casing. It cools to form a single grain bonded to the casing. Aluminum propellants of the type described above with an aluminum content of about 18 percent burns at a temperature of about 6100 degrees F. Increasing the aluminum content can increase the burn temperature and thrust. Higher temperatures can also destroy components of the rocket engine. The products of combustion include several gasses and alumina, Al₂O₃, (which has a 1 atmosphere melting point of 3720 F and boiling point of 5432 F). Inside the engine, the alumina is typically partly in its liquid phase and partly in its gaseous phase, depending on the local pressure.

### High Temperature Materials

Rocket nozzles must be able to handle these extremely high exhaust temperatures without failure. In some cases cooling of the throat can be provided, but in the case of solid fuel rockets this is normally not feasible. In some designs the nozzles are designed for some surface ablation. In other cases massive tungsten inserts are used in the nozzle throat to ensure adequate thermal diffusivity to keep the surface temperature of the nozzle below the melting point of tungsten which is 6170 degrees F. Tungsten has in the past been the preferred liner material but is limited to a propellant temperature in the range of 6000 F to avoid melting. Tungsten is heavy, relative to most materials. Other materials with higher melting points are known. For example, hafnium carbide has a melting point of about 7034 degrees F. (3890 degrees C.) but tests have shown that hafnium carbide oxidizes quickly in a hot Al₂O₃ environment and the HfO₂ (with a melting point of only 4996 degrees F.) is quickly blown away. For this reason HfC is known to be no good as an engine liner in a rocket using aluminum fuel.

FIG. 11 is a chart showing the melting points (in centigrade) of a variety of high melting point materials. Several transition metal carbides such as tantalum carbide and niobium carbide have high melting points but like HfC they also oxidize to form oxides with low melting points. Also these carbides are brittle at low temperatures. In the past these carbides have not been seriously considered as rocket engine liners for rockets using aluminum fuels.

### Free Energy

J. Willard Gibbs (1839-1903) used the ideas of enthalpy, entropy and spontaneity in a concept called free energy (AG). Free energy refers to the maximum amount of energy free to do useful work. It is related to enthalpy (H), temperature (T) and entropy (S) by the equation:
(ΔG)=(ΔH)−Δ(TS).

Free energy is also a measure of spontaneity. Negative values of (ΔG) indicate a forward (reactants make products) reaction. Positive values of (ΔG) indicate a reverse (products make reactants) system. If (ΔG)=0, the system is in equilibrium, where there is no forward or reverse reaction. At equilibrium, the composition of the system (amount of products and reactants) is constant.

### What Is Needed

Rocket engines are currently being designed to operate at temperatures in the range of 6500 degrees F. which is above the 6170 degree F. melting point of tungsten. What is needed is a high temperature material that can withstand temperatures in this range for use in rocket engine nozzles and in other similar high-temperature applications.

### SUMMARY OF THE INVENTION

The present invention provides an aluminum burning rocket engine lining. The lining material is or includes one or more transition metal carbides of tantalum, niobium or vanadium. Applicants have determined that in aluminum burning rocket engines molten Al₂O₃ coats the inside surface of the throat of the rocket nozzle protecting certain transition metal carbides from oxidizing reactions at temperatures below a specific temperature that Applicants call the reaction initiated temperature (RIT). Applicants have proven through calculations and tests that a variety of transition metal carbide compositions are as good as or better than tungsten as engine liner materials for aluminum burning rocket engines.

### BRIEF DESCRIPTION OF THE DRAWINGS

FIG. 1 is a drawing of a prior art solid fuel rocket engine.

FIG. 2 shows surface recession for some high temperature materials.

FIG. 2A is a chart for determining the RIT for the Al₂O₃—HfC reaction.

FIGS. 3A, 3B, 3C and 3D show details for testing high temperature samples.

FIG. 4 shows some test results.

FIG. 5 shows a recession curve for a preferred high-temperature material.

FIG. 6 shows some parameters as a function of carbon content.

FIGS. 6A and 6B show electron microscope images of TaC samples.

FIGS. 7A and 7B show preferred nozzle designs.

FIGS. 8A and 8B show elements of a Bellville washer type arrangement for reducing tension forces in TaC parts.

FIG. 9 shows a technique for holding TaC rings in a nozzle.

FIGS. 10A and 10B show an alternate throat design.

FIG. 11 is a chart showing melting points of some high melting point materials.

### DETAILED DESCRIPTION OF PREFERRED EMBODIMENTS

### Applicant's Research

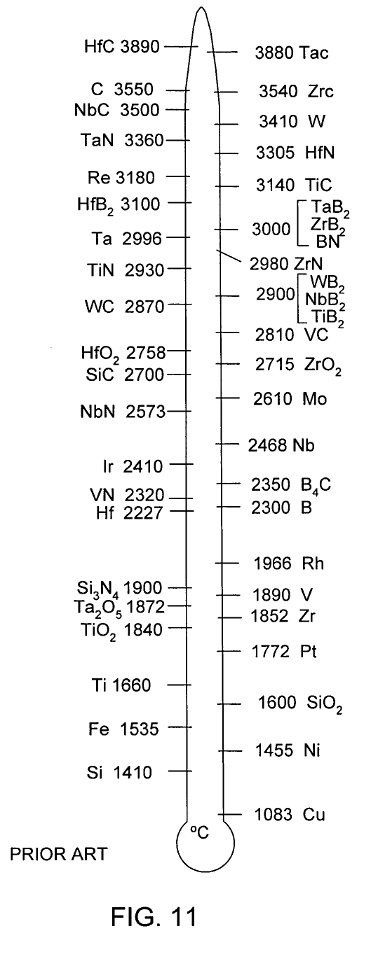

Carbides of the transistion metals, such as hafnium carbide (HfC), tantalum carbide (TaC) and niobium carbide (NbC), have very high melting points as shown in the FIG. 11 chart. Hafnium carbide has the highest melting point of any material on earth (see FIG. 11). However, as explained in the Background section, tests have shown that HfC performs very poorly as a liner material for an aluminum burning rocket. The HfC erodes away immediately in the hot alumina environment. The HfC oxidizes quickly in the hot alumina environment and the oxide of Hf with a melting point of 4996 F melts and is blown away. Since HfC, the highest melting point transition metal carbide has been shown to be a very poor material for rocket engines burning aluminum; TaC and NbC have not in the past been seriously considered as liners for aluminum burning rockets. For example the melting point of TaO₂ is only 3402 F and the melting point of NbO₂ is only 2754 F, both lower than the melting point of HfC. Applicants have investigated in depth, theoretically and experimentally, the reactions of transition metal carbides with the exhaust of aluminum burning solid rockets. This research (discussed below) explains why HfC makes a poor engine liner for these rockets and un-expectantly why TaC and NbC make excellent engine liners for aluminum burning rockets.

### Reaction Initiated Temperature (RIT) Model

One of the Applicants, Metcalfe, has developed a reaction initiated temperature model for transition metal carbides in a very hot Al₂O₃ environment. He determined that the two-phase mixture of molten and gaseous alumina will undergo separation as it passes through the nozzle. A layer of molten alumina forms on the inside surface of the nozzle and the layer is maintained by additional deposition. The molten alumina has very low viscosity at nozzle temperatures and flows rapidly across the surface. Reactions between the alumina and transition metal carbides are as follows:
MC₍ₛ₎+Al₂O₃₍₁₎>MO₂₍₁₎+2Al_{(g)}+CO_{(g)}

Applicant Metcalfe estimated the temperature where reactions between Al₂O₃ and the metal carbide begin. He calls this temperature, the “reaction initiation temperature” or the RIT”. His estimate of these RIT values corresponds to the temperature where the free energy of the products and reactants is equal to zero. His technique is as follows:
1) The free energy of the expected reactions is determined at several temperatures from existing references.
2) These free energies are then plotted as a function of temperature and extrapolated or interpolated to find an estimate of the temperature at which the free energy would be equal to zero.

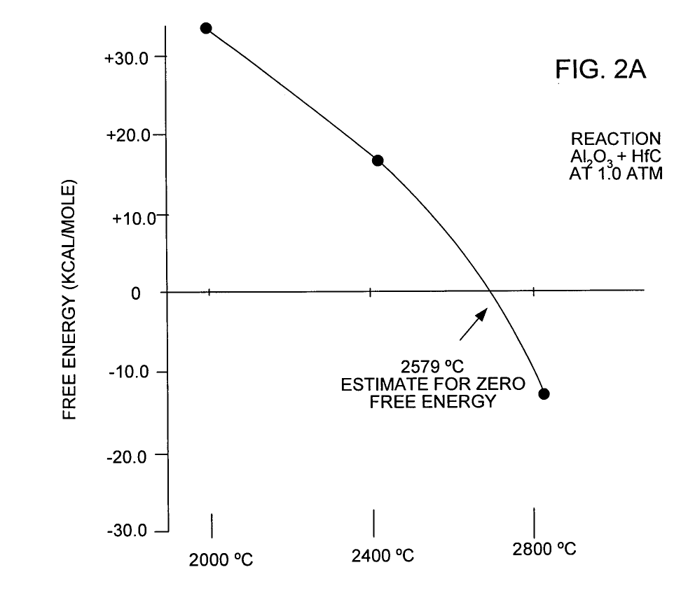

Table 1 shows Dr. Metcalfe's data for HfC in a hot alumina (Al₂O₃) environment. Dr Metcalfe assumed that the overall reaction can be broken down to four simple reactions. Al₂O₃ breaks down to Al and O₂, HfC breaks down to Hf and C, Hf and O₂ combine to form HfO₂ and C and O₂ combine to form CO. The free energy for each of these reactions is known and published in various reference books. For example as Table 1 shows, to break down Al₂O₃ into aluminum and oxygen at a temperature of 2000 degrees C., requires the addition of 225 kcal per mole at a pressure of one atmosphere. On the other hand, the oxidation of Hf releases 165 kcal per mole. The energy released and absorbed at each temperature (2000 C, 2400 C and 2800 C) is summed so that the net energy absorbed at 2000 C is +32.8 kcal/mole, the energy absorbed at 2400 C is +15.5 kcal/mole and the energy absorbed at 2800 C is −13.5 kcal/mole. (At 2800 C the net of the reactions is a release of energy.) These values of the net free energy are plotted for HfC in FIG. 2A. This graph indicates that at temperatures of 2579 C (about 4700 F) the HfC and alumina will begin to react with a release of energy whereas at temperatures below about 4700 F the reaction absorbs energy from the hot alumina. In many modern rocket engines the alumina is at temperatures of more than 6000 F and at these temperatures the reaction between alumina and HfC would be a rapid reaction resulting in failure of the HfC lining.

TABLE 1
Reactions between Al₂O₃ and HfC at 1 Atmosphere

| | Free Energy, G (kcals) | | |
|---|---|---|---|
| | 2000 C. | 2400 C. | 2800 C. |
| Al₂O₃ >> 2Al + 3/2 O₂ | +225 | +200 | +164 |
| HfC >> Hf + C | +47.3 | +46 | +44 |
| Hf + O₂ >> HfO₂ | −265 | −148 | −131 |
| C + 1/2O₂ >> CO | −74 | −82.5 | −90.5 |
| Al₂O₃ + HfC >> . HfO2 + CO + 2Al | +32.8 | +15.5 | −13.5 |

Dr Metcalfe applied the same technique to determine the zero free energy temperature for several other transition metal carbides. For example, some of the results of these calculations for TaC (equal molar content) are shown in Table 1. The RIT for TaC is 5442 F as compared to the RIT for HfC of only 4700 F, a difference of 742 F. RIT values for 13 transition metal carbide compositions along with their melting points are shown in Table 2. These are calculated for one atmosphere. At typical pressures in rocket nozzles, the RIT values will be several hundred degrees higher.

TABLE 2
RIT and Solidus of 13 Selected Compositions

| Formula | RIT (F.) @ 1 Atmosphere | Solidus (F.) |
|---|---|---|
| TaC, | 5442 | 6233 |
| TaC_{0.9} | 5521 | 7050 |
| Ta_{0.9}W_{0.1}C | 5524 | 5785 |
| Ta₂C | 5580 | 6030 |
| Ta_{0.36}Nb_{0.66}C | 5597 | 5790 |
| TaC_{0.8} | 5607 | 6780 |
| NbC | 5681 | 5980 |
| TaC_{0.7} | 5702 | 6350 |
| Ta_{0.36}Nb_{0.65}C_{0.826} | 5770 | 6602 |
| NbC_{0.9} | 5784 | 6370 |
| TaC_{0.6} | 5809 | 6045 |
| NbC_{0.8} | 5888 | 6530 |
| NbC_{0.7} | 5992 | 6350 |

The highest value of RIT in this group was the RIT for NbC_{0.7}. This was 5992 F, an RIT improvement over HfC of almost 1300 F. This value of RIT for NbC_{0.7} of 5992 F can also be compared to the melting point of tungsten of 6170. The melting point of NbC_{0.7} is 6350 F. All of the above RIT numbers are calculated for atmospheric pressure. Applicants estimate that at the operating pressure of typical high mass boost rocket engines, which are in the range of about 3000 psi, the RIT numbers should be several hundred degrees F. higher than the values calculated for 1 atmosphere.

### Applicants' Experiments

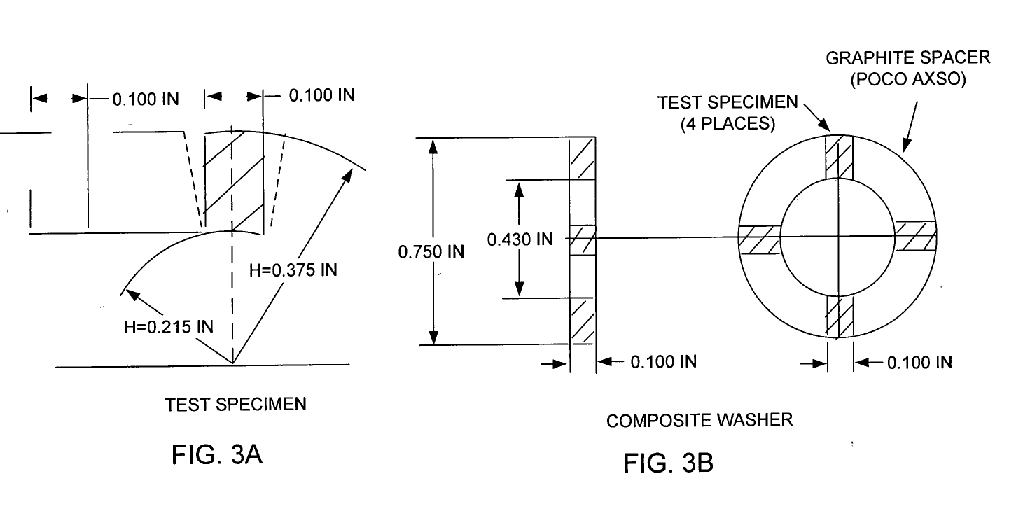

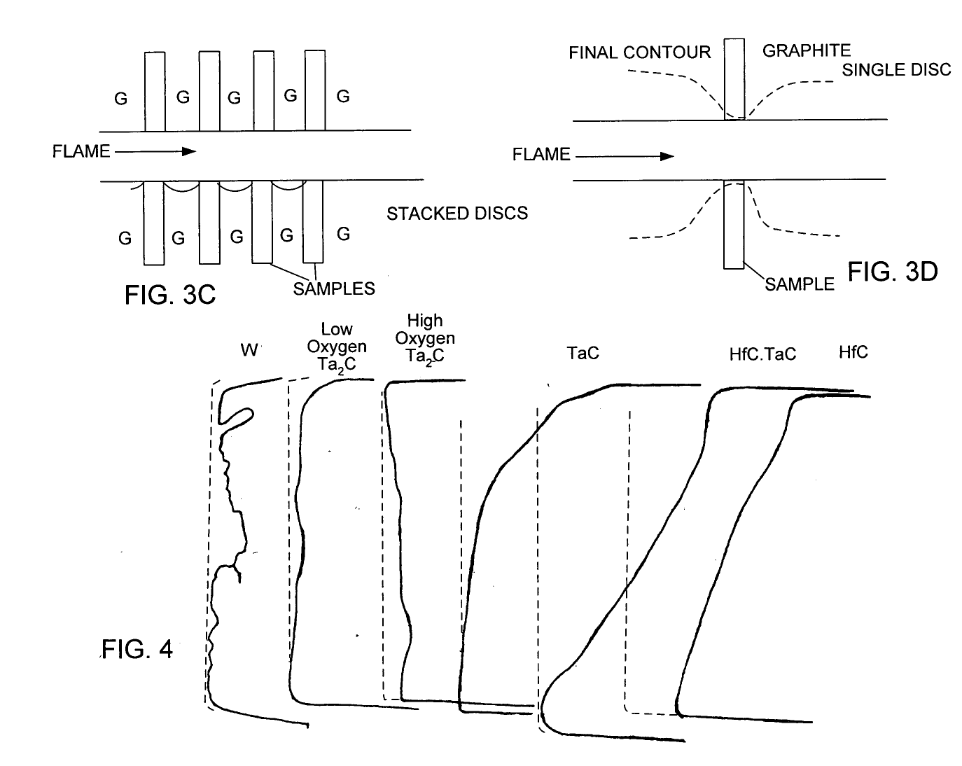

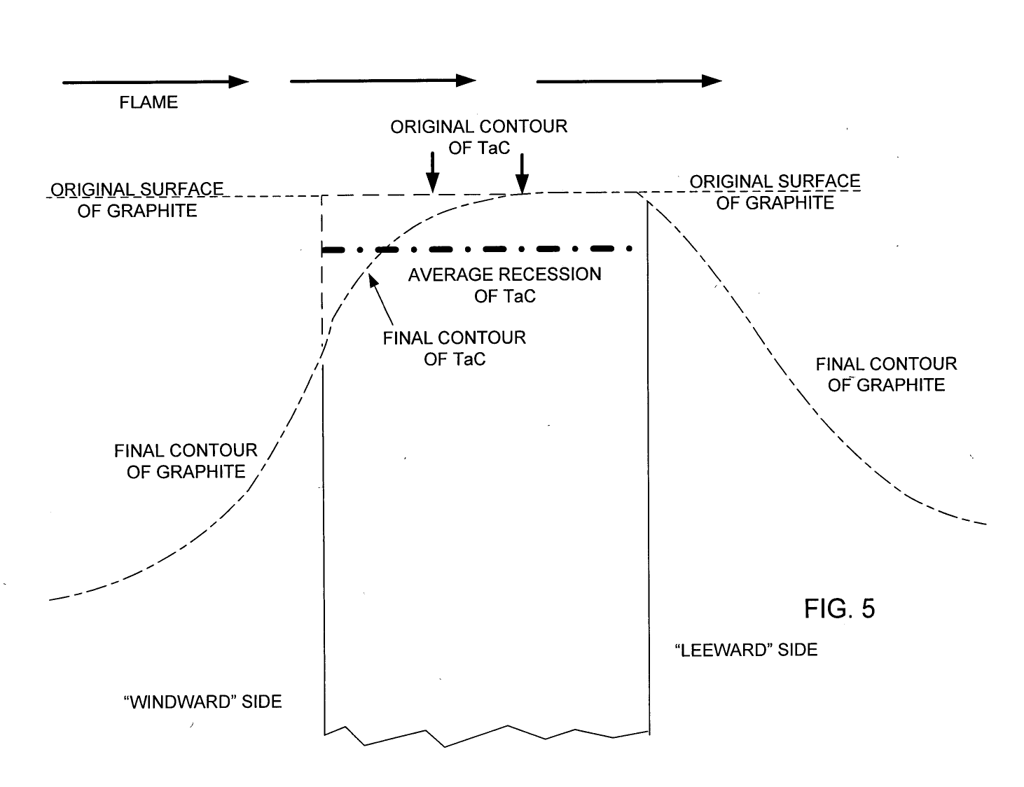

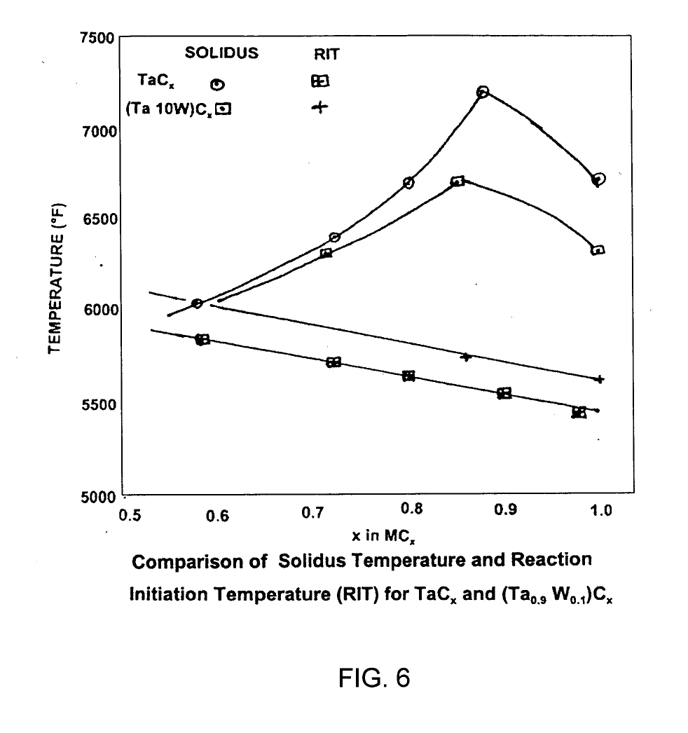

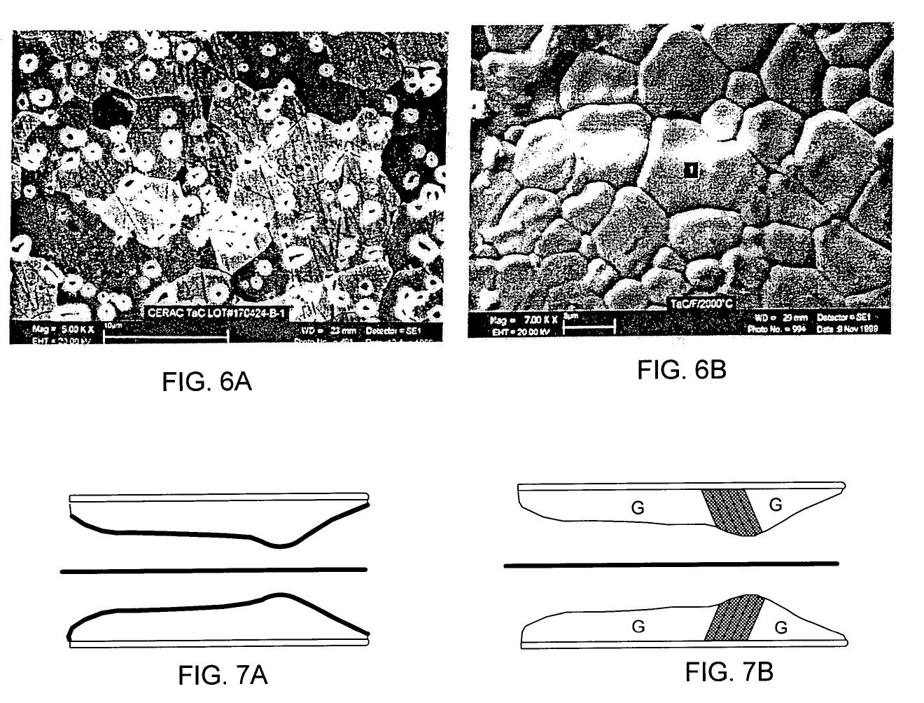

Applicants have created samples of Ta₂C, TaC, HfC.TaC and HfC. TaC samples were made from Ta material with significant oxygen contamination and from other Ta material with almost zero oxygen contamination. Tests by Applicants indicate that minimizing oxygen contamination improves performance. Good metal carbide samples were tested with similar tungsten samples in test set-ups like those shown in FIGS. 3A and 3B. The samples were made in the form of pellets with the dimensions shown in FIGS. 3A and 3B. Four of these pellets of each composition were assembled into a graphite ring configuration as shown in FIG. 3B for installation in the setups shown in FIGS. 3C and 3D. The samples were subjected to a burning aluminum flame. The results of these tests are shown in FIGS. 4 and 5. All samples of TaC and NbC created by Applicants out-performed the HfC samples as Applicants expected. The samples of TaC and NbC also outperformed the tungsten sample as shown in FIG. 4. Dashed lines show initial surface contour and solid lines show surface contour after a ten-second simulated aluminum fuel rocket engine nozzle test.

### TaC Erosion Rate Approaches Zero

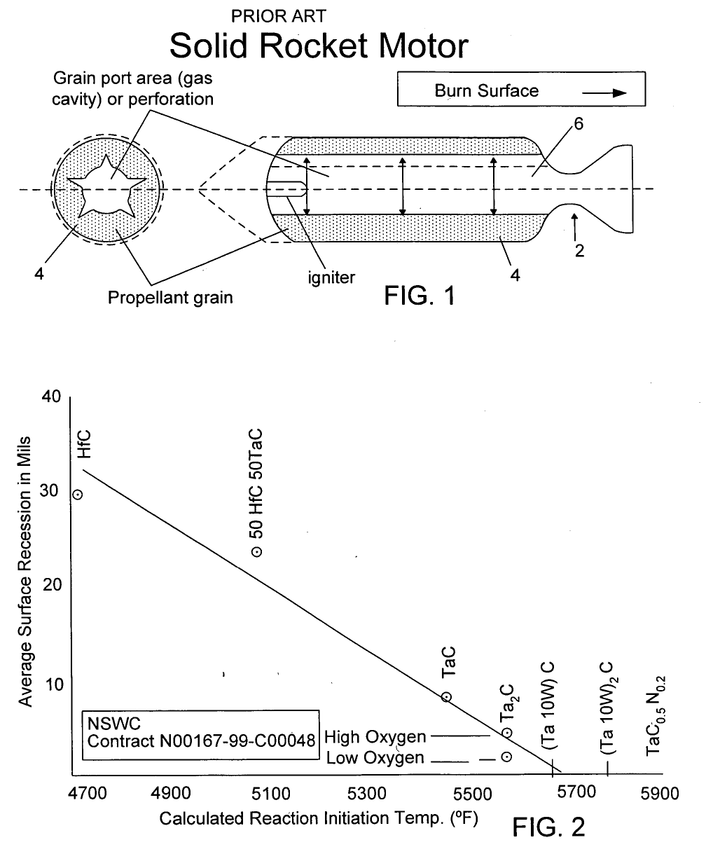

FIG. 5 shows that there was substantial erosion of the leading (windward) edge of the TaC sample but there was no significant erosion of the surface near the trailing edge. Applicants have explained the erosion near the windward side of the sample (as shown in FIG. 5) as being caused by the products of the graphite erosion interfering with the surface layer of Al₂O₃ that would have otherwise formed on the TaC sample. Applicants have determined that the Al₂O₃ did coat the leeward side of the sample and protected it from any significant erosion. The results for NbC samples are similar to the TaC results. Thus, Applicants calculations and actual tests show that the erosion rates of TaC and NbC liners in a high-temperature aluminum fueled rocket engines approach zero so long as the nozzle is designed to generate and preserve the Al₂O₃ molten layer on the surface of the liner. Applicants have determined that a layer of molten Al₂O₃ will form on the surface of an aluminum burning rocket nozzle of the type shown in FIG. 1. This layer reacts with a TaC liner or a NbC liner but the reaction rate is negligible at temperatures below the RIT for the TaC or the NbC and very low for temperatures somewhat above the RIT. Applicants' tests and calculations (such as those producing the Table 2 results) have shown that some TaC and NbC compositions are much better than other compositions for use as liner materials. These tests lead Applicants to believe that careful selection of material compositions could produce a greatly improved high-temperature material for applications like rocket nozzles. Applicant has compared density, RIT values (calculated for 1 atmosphere and estimated for 100 atmosphere) and melting points of four preferred liner materials (HfC, TaC_{0.89}, Ta_{0.9}W_{0.1}C_{0.89} and NbC_{0.79}) with tungsten in Table 3.

TABLE 3
Comparison of Transition Metal Carbides with Tungsten

| | | RIT (F.) | | |
|---|---|---|---|---|
| | Density | 1 Atm. | 100 Atm. | Melting Point |
| Material | (lbs/cu. In.) | Calculated | Estimated | (F.) |
| Tungsten | 0.7 | NA | NA | 6170 |
| HfC | 0.46 | 4710 | 5110 | 7102 |
| TaC_{0.89} | 0.5 | 5580 | 5980 | 7205 |
| Ta_{0.9}W0.1C_{0.89} | 0.52 | 5740 | 6140 | 6680 |
| NbC_{0.79} | 0.28 | 5960 | 6360 | 6535 |

The results of Applicants calculations and test as shown in Table 3 demonstrates that several transition metal carbides have properties that would permit them to perform as good as or better than tungsten as rocket engine liner material. In addition to the very high RIT values and melting points higher than tungsten, all of the materials shown in Table 3 are substantially less dense than tungsten. Lower density obviously is important in rocket design because this property means that the rocket can be made much lighter which reduces the work the rocket has to do and reduces costs.

The reader should note from Table 3 that reducing the carbon content in these metal carbides tends to improve various parameters. For example, although TaC (with equal concentrations of Ta and C) is an excellent liner material, Applicants have shown that much improved materials performance can be realized with careful attention to the metal to carbon ratios in the carbides of these transition metals. Applicants work has shown that reduction of the carbon-to-metal ratio results in:
1. Reduction in elastic modulus (less strain is developed for the same stress).
2. Increase in start of melting as compared to TaC_{1.0}.
3. Increase in the RIT over TaC._{1.0}.
4. Decreased ductile-brittle transition temperature (DBTT). Plasticity occurs at a lower temperature.
5. Permits surface carburization to create compression stresses at surface of inserts to counter tension at outer parts of inserts.

### Design Solutions

At low temperatures TaC and NbC are brittle. At high temperatures the materials become ductile. Therefore, rocket liner designs should take these features into account. In preferred liner designs Applicants propose the following general design solutions as preferred design techniques:
1. Apply compression to counteract that expansion.
2. Use an assemblage of carbide discs separated by graphite discs to permit free expansion.
3. Shape the discs in the form of Belleville washers to permit flexing to relieve expansion strains.
4. Contain the metal carbide elements by an external, ductile refractory metal ring (such as 90Ta-10W).
5. Compress the metal carbide elements by a shrunk-fit ring of 90Ta-10W so that the Ta Cₓ elements are in initial compression.

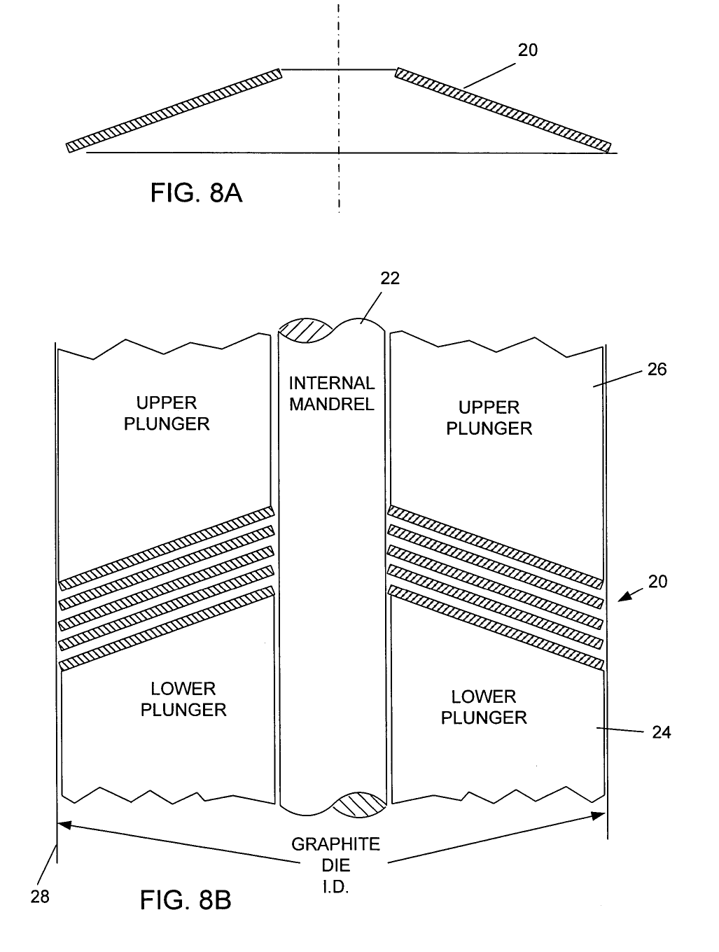

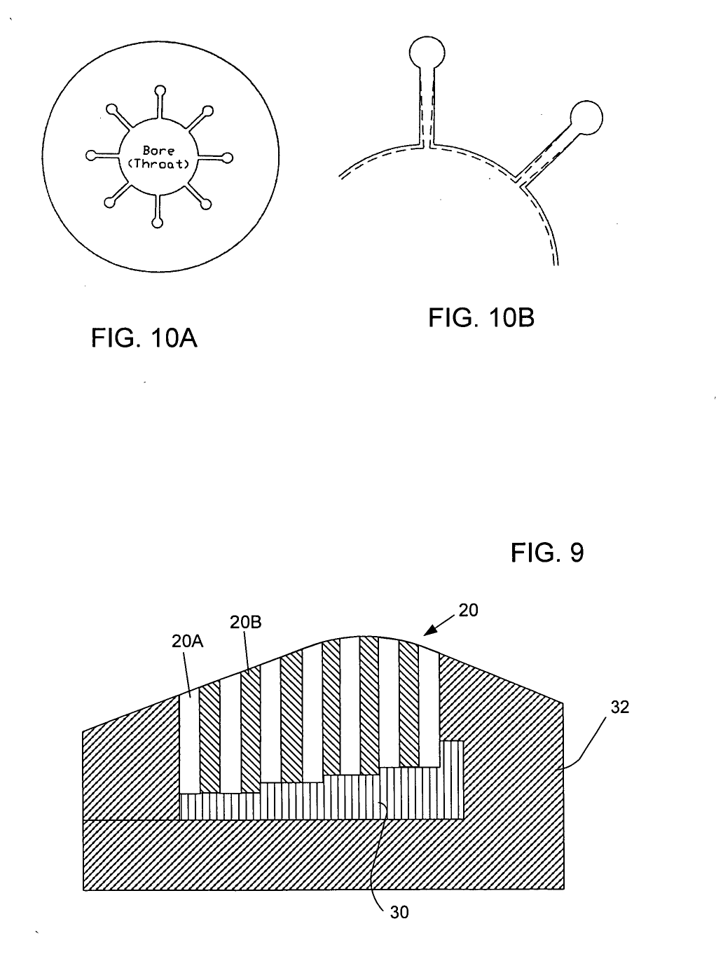

A preferred arrangement to fabricate a Belleville washer type stack-up suitable for a throat insert is shown in FIGS. 8A and 8B. The stack-up includes washers 20, inner mandrel 22, lower plunger 24, upper plunger 26 and graphite enclosing die 28. A throat section insert may be fabricated as shown in FIG. 9. This section includes washer stack 20 of graphite (preferably TMCC carbide) 20A and high-temperature material (such as TaC0.89) 20B, a 90Ta10W shrink fit containment ring 30, all fitted into nozzle body 32.

### Low-Cost Embodiment

In the above embodiments the high-temperature materials are fabricated using hot pressing of powdered Tantalum and powdered carbon at temperatures of about 2200 degrees Centigrade and pressures of about 6000 psi. These materials may also be made with other techniques such as plasma spraying. All these prior art techniques for making materials such as TaC are expensive. Also, any after fabrication machining is very expensive since the material is so hard. Techniques such as electro-discharge machining are typically used.

As an alternative for rocket nozzle, Applicants propose that the TaC be produced in place using the heat and pressure of the rocket engine. For this embodiment, thin foils (about 2 mils thick) are alternately wrapped on a mandrel to form the throat of the nozzle. When the desired thickness is obtained the foils can be held in place with carbon string. The mandrel is removed and the throat is fixed firmly into the nozzle. When the engine ignites the foils react exothermically with each other to form TaC in situ. These foils are commercially available (Ta from Wah Chang, Albany, Oreg. and graphite foil is sold commercially as Graphoil). Carbon string is available from many suppliers. The engine temperature is somewhat higher than the preferred hot pressing temperature and the pressure is somewhat lower, but Applicants believe this technique will produce a good relatively very inexpensive nozzle throat design that will do the job.

To minimize the initial temperature shock on ignition, a thin coating of Al₂O₃ and/or TaC could be plasma sprayed on the inner surface of the throat. An important advantage of this design is that it is not brittle an can easily withstand tension stresses while heating up.

This technique could also be used to provide NbC rocket engine liners by using Nb foil in the place of the Ta foil.

While the above description describes preferred embodiment of the present invention in detail, the reader should understand that many changes could be made without departing from the spirit of the invention. For example, vanadium is a transition metal chemically similar to tantalum and niobium, so Applicants believe that its carbide VC also could be utilized as a liner for aluminum burning rocket engines. Vanadium carbide is relatively very light which would be an important advantage in many applications. Many variations in the amount of carbon could be used other than the ones specifically identified. Varying amounts of tungsten could be added other than the specific amount shown in Table 3 although preferably the tungsten content should be less than 10 percent. Therefore the reader should determine the scope of the invention by the appended claims.

We claim:

1. An aluminum burning rocket engine lining comprising a composition of carbon and a transition metal chosen from the following group of transition metals: tantalum, niobium and vanadium.

2. The lining of claim 1 wherein said composite also comprises tungsten.

3. The lining as in claim 2 wherein said tungsten represents a percent molar content of less than 10 percent of said composite.

4. The lining as in claim 1 wherein the transition metal is tantalum.

5. The lining as in claim 1 wherein the transition metal is niobium.

6. The lining as in claim 1 wherein the transition metal is vanadium.

7. The lining as in claim 1 wherein the chemical composition of the composite is approximately equal to a composition chosen from the following group of transition metal composites: TaC, TaC_{0.9}, Ta_{0.9}W_{0.1}C, Ta₂C, Ta_{0.36}Nb_{0.66}C, TaC_{0.8}, NbC, TaC_{0.7}, Ta_{0.36}Nb_{0.65}C_{0.826}, NbC_{0.9}, TaC_{0.6}, NbC_{0.8} and NbC_{0.7}.

8. The lining as in claim 1 wherein said lining is held in place by an expansion accommodating compression means.

9. The lining as in claim 1 wherein said lining is comprised of an assemblage of carbide discs separated by graphite discs to permit free expansion.

10. The lining as in claim 9 wherein said discs are in the form of Belleville washers to permit flexing to relieve expansion strains.

11. The lining as in claim 8 wherein said expansion accommodating compression means comprises an external, ductile refractory metal ring.

12. The lining as in claim 11 wherein the ductile refractory metal ring is a shrunk-fit ring of 90Ta-10W holding the transition metal composite elements in compression.
